(19) United States
(12) Patent Application Publication
(10) Pub. No.: US 2007/0258862 A1
(43) Pub. Date: Nov. 8, 2007

(54) Variable volume dispenser and method

(75) Inventor: Charles S. Vann, El Granada, CA (US)

Correspondence Address: KILYK & BOWERSOX, P.L.L.C., 3603 CHAIN BRIDGE ROAD, SUITE E, FAIRFAX, VA, 22030, US

(73) Assignee: Applera Corporation, Foster City, CA (US)

(21) Appl. No.: 11/799,546

(22) Filed: May 2, 2007

Related U.S. Application Data
(60) Provisional application No. 60/796,679, filed on May 2, 2006.

(51) Int. Cl. B01L 3/00

(52) U.S. Cl. 422/99

(57) ABSTRACT

A variable volume dispenser contains a set of one or more fill tubes, each having a rod or other volume-limiting member slidably mounted therein. Suction pressure can aspirate supported oligonucleotide beads or other powder, granulate, or particulate material into the fill tubes for dispensing selected volumes into wells or other containers. The rods or other members can be constructed to comprise a filter having a pore size smaller than the particulate material to be manipulated so that the material cannot be lodged inside the fill tube. In various embodiments, the volume of powder or other material to be aspirated can be selectively set by moving the rods to different locations within the fill tubes using electromagnets. In various embodiments, individual rods can be independently activated.

### CROSS-REFERENCE TO RELATED APPLICATION

This application claims priority to U.S. Provisional Application No. 60/796,679, filed May 2, 2006, entitled “Variable Volume Dispenser,” which application is incorporated by reference in its entirety herein.

### INTRODUCTION

The section headings used herein are solely for organization purposes and are not to be construed as limiting the subject matter described in any way. Embodiments of the present teachings relate to a device for dispensing powder, beaded, or other granular or other material.

### SUMMARY

According to various embodiments of the present teachings, a dispenser apparatus and dispensing method can comprise the aspiration or uptake of a powder, particles, beads, or other granular or particulate material, into a fill conduit or other fill channel, fill chamber, or fill tube, for example, using suction created by a vacuum. According to various embodiments, the granular or particulate material can comprise beads, for example, supporting oligonucleotides that have been prepared for use in biological assays. Exemplary assays include DNA sequencing or other assays, chemistries, tests, or procedures. According to various embodiments, a volume limiting element, such as a rod or piston, can be selectively moved to a position within the fill tube to provide a desired volume for receiving the granular or other particulate material from an originating container holding such material. According to various embodiments, a marginal or peripheral space between the volume limiting element and an inner wall of the fill tube can be provided to permit the passage of air by pressure differential around the volume limiting element. According to various embodiments, a dispenser apparatus and dispenser method can be provided having or using multiple fill tubes, in which the position of one or multiple rods, pistons, or other members can each be adjusted within the respective tubes to vary the volume of powder or other material aspirated and dispensed, individually or collectively. According to various embodiments, the beads or other material can be aspirated or drawn into the fill tube by drawing air into the fill tube through the marginal voids between the volume limiting element and the inner wall of the fill tube.

According to various embodiments, each of the volume limiting elements defining the volumes in the respective fill tubes can be independently controlled. According to various embodiments, once a desired volume of beads or other material is withdrawn from an originating container into the fill tube, the fill tube can be transported under motor control or other mechanical action to a position over a receiving container, a mixing container or another location. According to various embodiments, air pressure can be administered to push the beads or other material out of the fill tube and into the receiving container, mixing container, or other location.

### BRIEF DESCRIPTION OF THE DRAWINGS

FIG. 1 illustrates a variable volume dispenser, according to various embodiments of the present teachings.

FIGS. 2(A)-2(D) illustrate various aspiration and dispensing actions, according to various embodiments of the present teachings.

FIG. 3 illustrates a cleaning action of a rod and a fill tube, according to various embodiments of the present teachings.

FIG. 4 illustrates a variable volume dispenser including multiple rods and fill tubes, according to various embodiments of the present teachings.

FIGS. 5(A)-5(C) illustrate selectable actuation of rods according to various embodiments of the present teachings.

FIG. 6 illustrates a rod having a filter according to various embodiments of the present teachings.

FIGS. 7(A)-7(D) illustrate the aspiration and dispensing of a powder, according to various embodiments of the present teachings.

FIG. 8 illustrates bead aspiration and delivery test data, according to various embodiments of the present teachings.

FIG. 9 illustrates a cleaning action of a rod having a filter and fill tube, according to various embodiments of the present teachings.

FIG. 10 illustrates a variable volume dispenser, according to various embodiments of the present teachings.

FIGS. 11(A)-11(C) illustrate various aspiration and dispensing actions, according to various embodiments of the present teachings

Other various embodiments of the present teachings will be apparent to those skilled in the art from consideration of the specification and practice of the devices, systems, and methods described herein, and the detailed description that follows. It is intended that the specification and examples be considered as exemplary only.

### DESCRIPTION OF VARIOUS EMBODIMENTS

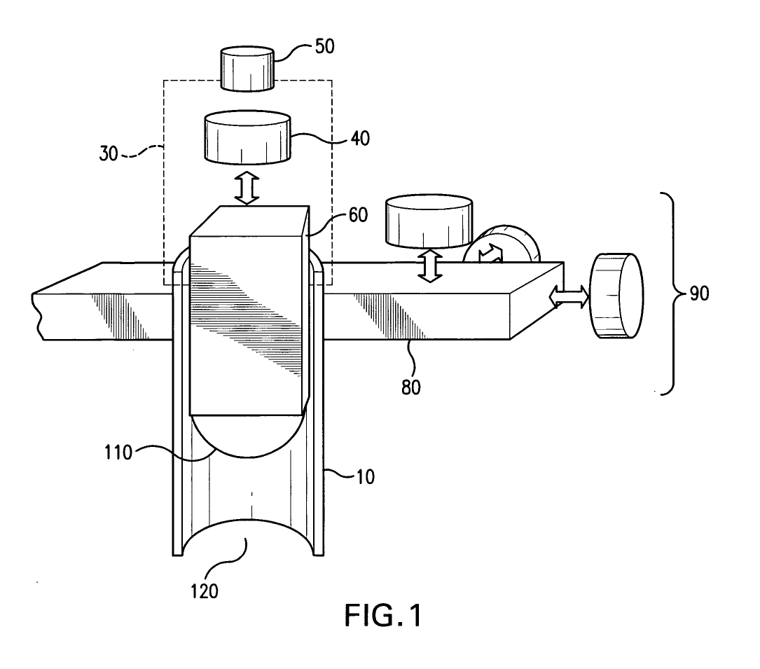

FIG. 1 illustrates a dispenser apparatus, according to various embodiments of the present teachings. According to various embodiments as shown, the dispenser apparatus can comprise a rod 60 that can movably slide inside of a fill tube 10, or other fill conduit or receiving tube, channel, chamber, or plenum. According to various embodiments, rod 60 can be rectangular (as shown), or in various embodiments, can be cylindrical, polygonal, tapered, or have other shapes. According to various embodiments, rod 60 or other members can act as a volume limiter, by blocking or occupying a certain volume of space within fill tube 10, while permitting a desired volume to remain open and unoccupied. According to various embodiments, rod 60 or another volume limiting element can be fitted within fill tube 10 to allow or create marginal or peripheral passages, channels, or clearances between rod 60 and an inner surface of fill tube 10, permitting air or other gases or fluids to pass around rod 60 and through fill tube 10 through those passages. According to various embodiments, rod 60 and/or fill tube 10 can be made of glass, metal, plastic, or other material. According to various embodiments, rod 60 can be of unitary construction, or can be made of multiple parts. According to various embodiments, rod 60 can be rigid, or can be flexible. According to various embodiments, a protruding or distal tip of rod 60 can be shaped with a blunt, rounded rod end 110 (as shown), or have other shapes or constructions. According to various embodiments, fill tube 10 can be made of transparent material, for instance, to permit inspection of the interior of fill tube 10 including aspirated loads, for example, by visual inspection, or by electronic or optical sensors.

Rod 60 can be sized to fit snugly in fill tube 10 within a comparatively tight margin of clearance between rod 60 and the inner sleeve or inner surface of fill tube 10, such that a powder, for example, supported oligonucleotide beads or other granulate or particulate material cannot pass around rod 60 and further into fill tube 10. According to various embodiments, rod 60 can nevertheless fit inside of fill tube 10 with enough clearance to permit rod 60 to move relatively easily, freely, slidably, or reciprocatingly inside of fill tube 10. According to various embodiments, rod 60 can also be configured to rotate inside of fill tube 10. According to various embodiments, the inner surface of fill tube 10 and/or surface of rod 60 can, for instance, be coated or treated with an anti-friction coating or material, such as a polytetrafluoroethylene, or other treatment, coating, or anti-friction material.

According to various embodiments, fill tube 10 can be fixed to a support 80, such as a plate, table, platen, arm, shelf, or other structure. Rod 60, in various embodiments, can be free to move relative to support 80. According to various embodiments, a volume control motor 40 can move rod 60 inside of fill tube 10. According to various embodiments, volume control motor 40 can be or comprise a linear motor, or another source of mechanical drive. According to various embodiments, volume control motor 40 can move rod 60 within fill tube 10 in reciprocating fashion, or provide other mechanical movements, or actions. According to various embodiments, volume control motor 40 can accurately control an aspirated volume of powder 140, because the position of rod 60, acting as a volume limiter, determines the volume of powder 140 that will be collected inside the tube 10.

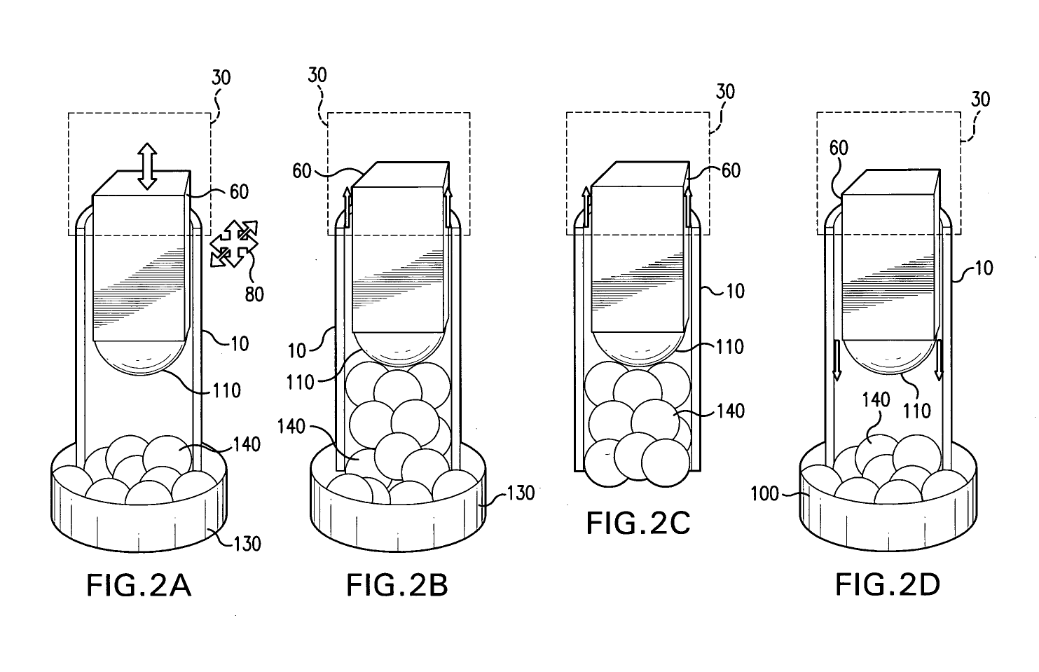

According to various embodiments, a set of one or more support motors 90 can drive support 80 such that the open end 120 of fill tube 10 can be moved into a desired position. According to various embodiments, and as for example, illustrated in FIGS. 2(A)-2(D), the set of support motors 90 can translate or move open end 120 of fill tube 10 into, above, or otherwise adjacent and/or aligned with a container 130 of powder 140. The set of support motors 90, in various embodiments, can comprise three motors, or less or more motors. According to various embodiments, three motors can be used, for example, to drive movement and translation of support 80 in respective perpendicular or orthogonal (x, y, z) directions. According to various embodiments, other numbers, orientations, and configurations of a set of support motors 90 can be used. According to various embodiments, rod 60 and fill tube 10 can be mounted in an airtight container 30 or other sleeve or enclosure. According to various embodiments, an air pump 50 can induce negative or positive air pressure in fill tube 10, by exerting pressure or vacuum through or on airtight container 30.

FIGS. 2(A)-2(D) further illustrate various operations of a variable volume dispenser, according to various embodiments of the present teachings. As shown in FIG. 2(A), rod 60 can be moved by volume control motor 40 or other mechanical drive unit to a position within the fill tube 10 to set the available volume in fill tube 10 to receive a certain volume of powder 140 or other material, as desired. As shown, for instance, in FIG. 2(B), a negative gas pressure (vacuum) can be induced or applied at the upper end of rod 60 using air pump 50 or another pressure or vacuum source, to cause powder 140 or other material to be sucked or aspirated into the available volume in fill tube 10, from container 130 or from another source or support. According to various embodiments, the diameter of the particles of powder 140 or other material can be larger than any peripheral space or clearance between rod 60 and tube 10, such that the powder 140 can not pass by or around the rod 60.

According to various embodiments as shown in FIG. 2(C), the vacuum exerted by air pump 50 can retain or hold a set or defined volume of powder 140 within fill tube 10, once the defined volume is extracted or aspirated from container 130. According to various embodiments, powder 140 can be retained in fill tube 10 while fill tube 10 is stationary, or, for instance, during transport or during other handling of fill tube 10. When powder 140 is ready to be dispensed, as shown in FIG. 2(D), the applied negative gas pressure can be turned off and a positive gas pressure can be created to force air or other gas around the peripheral clearance between rod 60 and fill tube 10, thus blowing or pushing powder 140 out of fill tube 10 and into a receiving container 100. According to various embodiments, container 100 can be or comprise, for instance, a shipping container for delivery of powder 140 to a clinical laboratory or other destination, or to another type of receptacle.

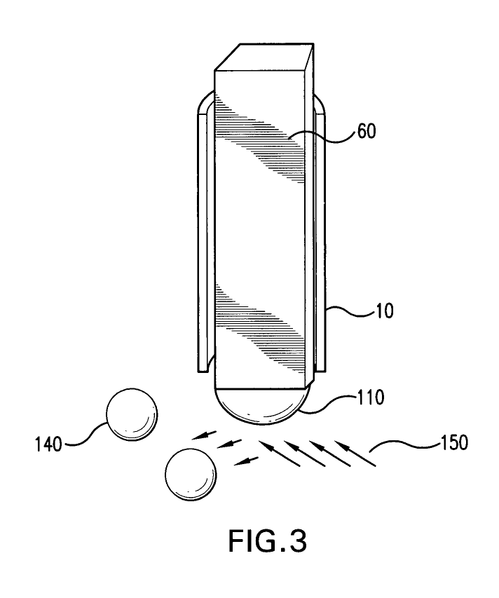

According to various embodiments of the present teachings, and as shown in FIG. 3, rod 60 can be extended outside of fill tube 10 to provide access or exposure for cleaning of rod end 110 and other portions of the dispensing apparatus. According to various embodiments, it can be possible for beads from powder 140 or other material to adhere to rod end 110 after a dispending operation is completed or at other times, for instance, due to electrostatic or other attractive or adhesive forces. According to various embodiments, it can be possible for beads from powder 140 or other material to lodge or adhere to the lip or interior surface of fill tube 10, also, for instance, due to electrostatic or other attractive or adhesive forces. In case of any accidental adhesion or lodging of residual amounts of powder 140, a portion of powder 140 or other material lodged inside or on the lip or other areas of fill tube 10, or on rod end 110 or on other portions of rod 60, or on another member of the dispensing apparatus, can be forced out by rod 60, and/or blown away by forced air 150 or by another scouring agent. According to various embodiments, rod 60 can be extended or reciprocated within fill tube 10 to eject or remove residual powder 140. According to various embodiments, forced air 150 or another scouring agent can be directed at rod end 110 from a separate nozzle, or other source. According to various embodiments, other material than forced air 150, for example, water or other gas, liquid, or solvent, can be directed at rod end 110 or at another portion of the dispensing apparatus, for cleaning activity.

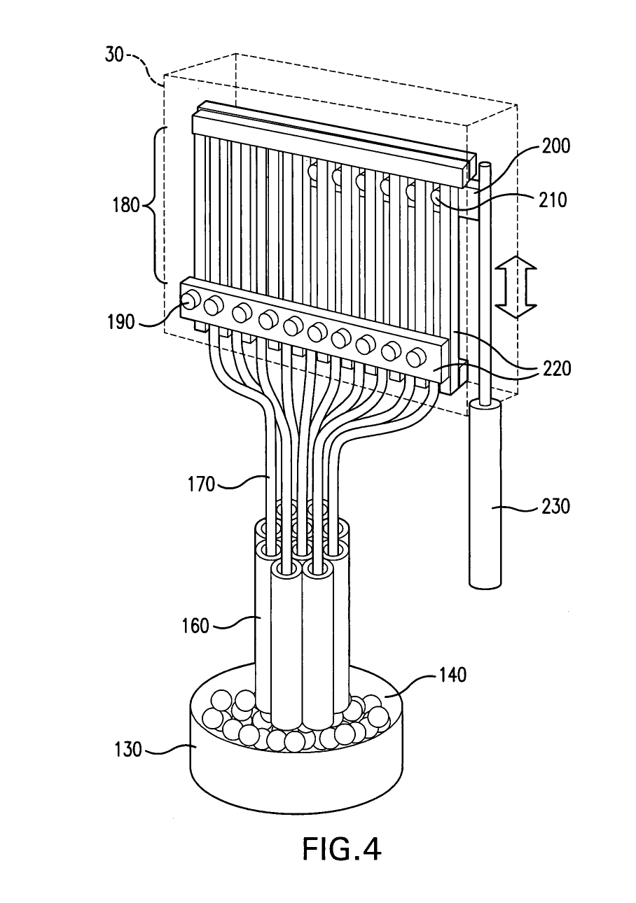

According to various embodiments of the present teachings, a dispensing apparatus can be provided that comprises multiple tubes and/or rods for aspiration and dispensing. According to various embodiments as illustrated, for instance, in FIG. 4, a dispensing apparatus can be provided with a set of fill tubes 160, each of which are matched with one of a set of rods 170 that can be independently actuated. The upper ends of the rods in the set of rods 170 can be mounted between opposing fixed plates 220. One fixed plate of opposing fixed plates 220 can be configured with a set of electromagnets 190 that can be activated to hold one or more of the rods of the set of rods 170, by magnetic force, in the lowest extended position in its respective fill tube. Another, motorized plate 200 of opposing fixed plates 220 can be motorized, and can be configured with a set of extract electromagnets 210 that can be activated to hold one or more rods in the set of rods 170 such that those rods can be extracted from their respective fill tubes, when the motorized plate 200 moves upwards.

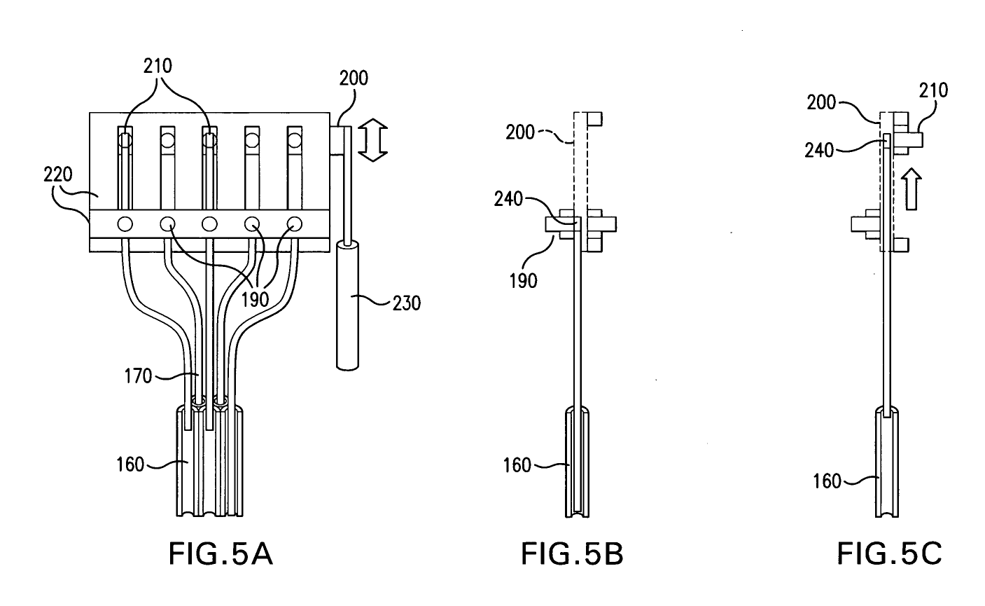

FIGS. 5(A)-5(C) illustrate a set of mechanical actions, according to which selected rods in the set of rods 170 can be extracted inside their respective tubes when the set of electromagnets 210 are activated to extract and the motorized plate 220 consequently moves upwards. The remaining, unselected rods are held in a no-fill position (for example, with rod end 110 flush with open end 120 of fill tube 10) by activation of the set of hold electromagnets 190. The extracted rods can be returned to the no-fill position by moving the motorized plate 200 back down with the set of extraction electromagnets 210 being activated. According to various embodiments, individual rods in the set of rods 170 can be fitted with a metal tip 240 (for example, a metal cap or fitting on a fiber optic rod), to enable selective coupling or binding between an activated electromagnet and an associated rod. According to various embodiments, the rods of the set of rods 170 can be made of metal, glass, plastic, or other material. According to various embodiments, the set of rods 170 can be arranged in a planar array (as shown), or in other configurations. According to various embodiments, each rod of the set of rods can be made or configured similarly to rod 60 described above, or otherwise.

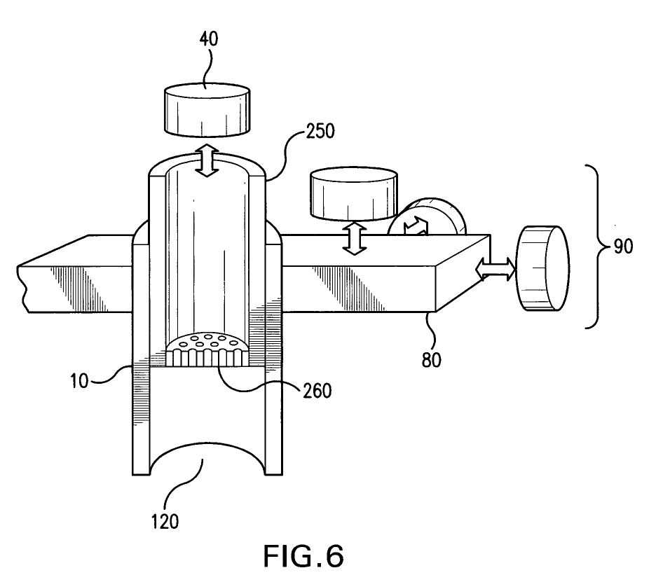

According to various embodiments of the present teachings, a volume limiter, such as a rod or other member, can be provided with an integral or associated filter, to filter or block particles of powder or other material. According to various embodiments, and as for instance shown in FIG. 6, a dispenser apparatus can comprise a configuration with a rod 250 that is hollow, and has a filter 260 at the distal end thereof. Filter 260, in various embodiments, can be built or configured with small slits, holes, pores, or other perforations or passages that can pass air, but block powder or other material of a particular diameter and larger. Filter 260, in various embodiments, can be or include a thin metal disk with perforations or holes, such as laser drilled holes. According to various embodiments, filter 260 can be or include membranes or screens. According to various embodiments, filter 260 can comprise one layer, or multiple layers or types of filter structures or material. According to various embodiments, fill tube 10 can be fixed to a support 80, but rod 250 can be free to slide or move relative to the support 80. According to various embodiments, a volume control motor 40 can move rod 250 inside fill tube 10 to adjust, set, or determine the volume of the powder or other material collected inside fill tube 10. The set of one or more support motors 90 can drive support 80 such that the open end of fill tube 10 can be driven to a desired position, for example, above or otherwise adjacent or into a container 130 of powder 140. According to various embodiments, powder 140 can comprise beads used for oligonucleotide synthesis, or other powder, granular, or particulate material.

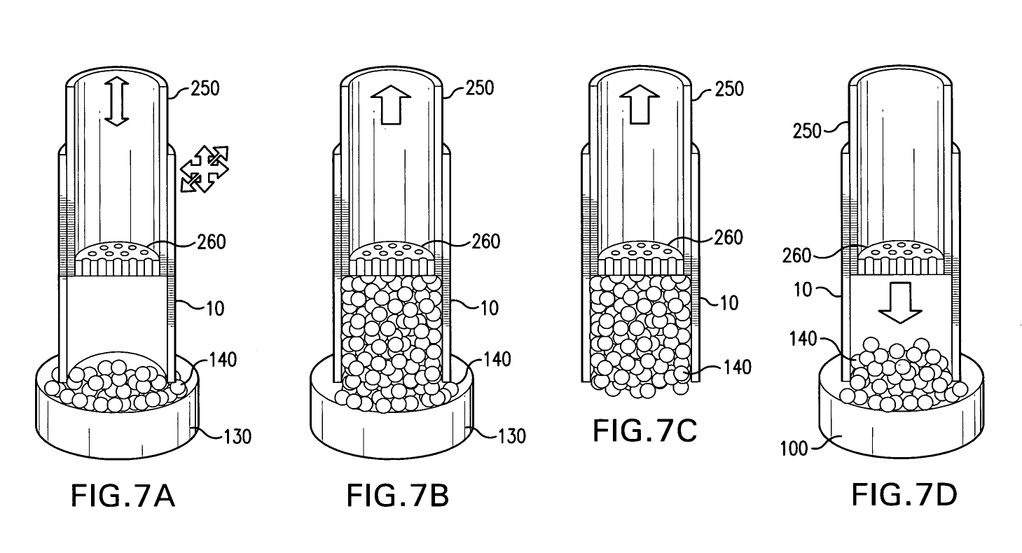

FIGS. 7(A)-7(D) illustrate various aspiration and dispensing operations of a variable volume dispenser, according to various embodiments of the present teachings. According to various embodiments shown in FIG. 7(A), rod 250 can be moved to a position within fill tube 10 to adjust, set, or determine the powder volume desired to be aspirated or extracted and dispensed, or otherwise manipulated. As shown in FIG. 7(B), a negative gas pressure (vacuum) at the upper end of rod 250 and through filter 260 can be induced by an air pump to cause powder 140 to be aspirated or sucked into fill tube 10. According to various embodiments, the diameter of each grain of powder 140 can be larger than the holes or other passages in filter 260, such that powder 140 cannot pass through filter 260. As shown, for instance, in FIG. 7(C), the vacuum can retain or hold a set or defined volume of powder 140 within fill tube 10 while fill tube 10 is stationary, or, for instance, during transport or other handling of fill tube 10. As shown in FIG. 7(D), according to various embodiments, the negative gas pressure can be reversed to create a positive gas pressure that forces gas through filter 260, pushing the powder out of fill tube 10 and into a receiving container 100 or other destination.

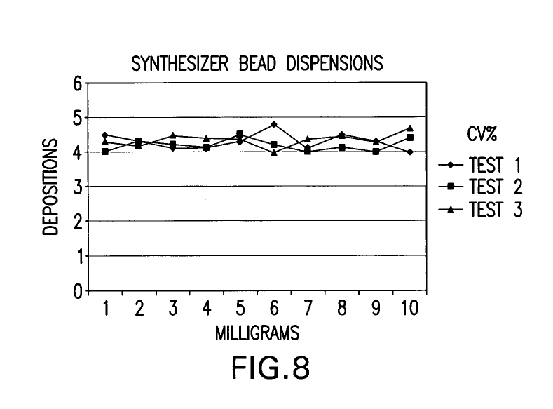

According to various embodiments of the present teachings, the ability to select defined, partial volumes of fill tube 10 to extract, receive, and dispense powder 140 or other material, can result in more precise and more uniform dispensing of oligonucleotide beads, or other content. FIG. 8 illustrates test data related to the coefficient of variance (CV) and other results achieved when aspirating and dispensing beads, according to various embodiments of the present teachings. According to test data as shown, good accuracy and consistency (CV consistently less than 5%) was achieved while extracting and depositing beads in total amounts (here measured in mass, mg) that varied by approximately an order of magnitude, from 1.0 to 10 mg.

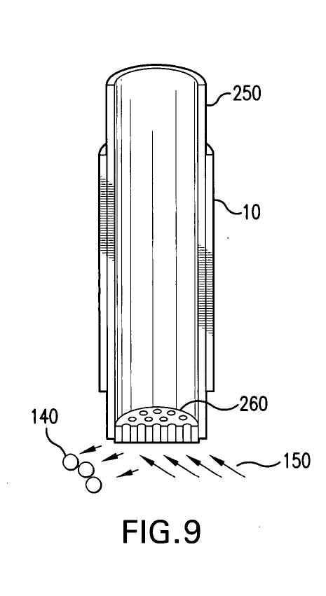

According to various embodiments, and as for example shown in FIG. 9, a rod 250 fitted with a filter 260 can be cleaned using directed air or other scouring or cleaning agents. As shown in FIG. 9, according to various embodiments, rod 250 can be extended outside of fill tube 10 to provide access for cleaning or other maintenance. Similar to embodiments illustrated in FIG. 3, in case of accidental adhesion or lodging of residual amounts of powder 140, beads from powder 140 or other material lodged inside or on the lip or other areas of tube 250 or on filter 260, or other member of the dispensing apparatus, can be forced out by rod 250, and/or blown away by forced air 150 or by another scouring agent. According to various embodiments, rod 250 can be extended or reciprocated within tube 10 to eject or remove residual powder 140. According to various embodiments, forced air 150 or other scouring agent can be directed at filter 260 from a separate nozzle, or other source. According to various embodiments, other material than forced air 150, such as, for example, water or other gas, liquid, or solvent, can be directed at filter 260 or at another portion of the dispensing apparatus, for cleaning activity.

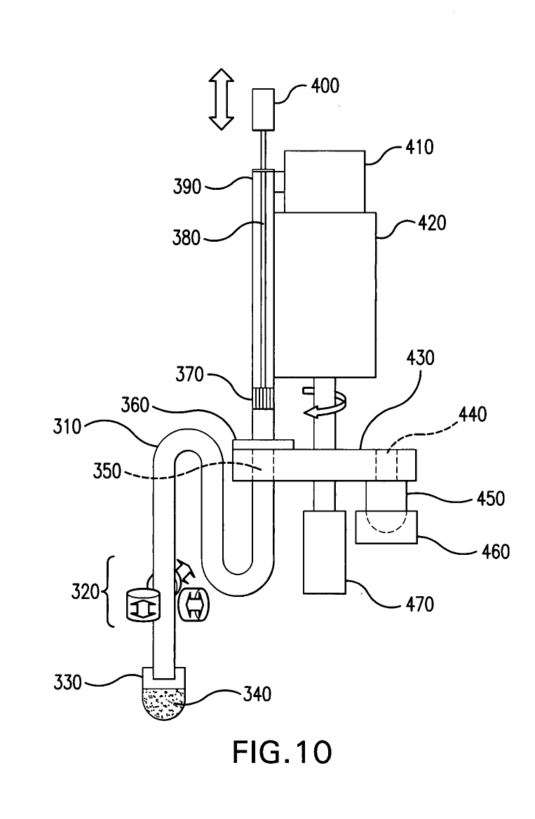

According to various embodiments of the present teachings as illustrated in FIG. 10, a dispenser apparatus can comprise a tube 310 into which powder 340, such as oligonucleotide beads, powder, granulate, or other particulate material can be aspirated, drawn, and/or ingested. According to various embodiments, powder 340 can be aspirated into tube 310 from container 330, which can be positioned over, at the edge of, inside, or otherwise adjacent or in close proximity to container 330 under control of a set of support motors 320. The set of support motors 320 in various embodiments can comprise three motors, or less or more motors. According to various embodiments, three motors can be used, for example, to drive movement and translation of tube 310 and/or associated components in respective perpendicular or orthogonal (x, y, z) directions. According to various embodiments, other numbers, orientations, and configurations of the set of support motors 320 can be used.

According to various embodiments as shown in FIG. 10, tube 310 can be provided in a serpentine or S-shape. According to various embodiments, other shapes or configurations of tube 310 can be used. According to various embodiments, tube 310 can be received, connected, joined, mated, or otherwise attached or registered with a bore 350 in a support 430. According to various embodiments, bore 350 can communicate with a tube 390 in which a piston rod 380 terminating in a piston head 370 is coaxially, slidably mounted. According to various embodiments, tube 390 can have a gasket 360 affixed at one distal end thereof, that mates, registers, or otherwise attaches to or through bore 350 of support 430. According to various embodiments, piston rod 380 can be actuated by a volume control motor 400, such as a linear motor or other motor or other source of mechanical drive.

According to various embodiments, tube 390 can be in fluid communication with an air pump 410, to provide suction or pressure to the interior of tube 390, and thereby aspirate or dispense powder 340 into or out of tube 390, as in other embodiments described herein. According to various embodiments, a peripheral or marginal clearance between piston head 370 and tube 390 can permit a channel or conduit for air flow to produce suction or pressure during those operations.

According to various embodiments as shown in FIG. 10, a rotational support 420 can be mounted and configured to rotate tube 390 and associated components under power of a rotational motor 470, to perform various aspiration and discharge operations. According to various embodiments, that rotation can align tube 390 over a separate bore 440 in support 430, used as a discharge bore to dispense power 340 under air pressure into a container 450 mounted or supported by a receiving support 460. According to various embodiments, control, handling, and delivery of powder 340 or other granular or particulate material can be conducted using rotational movement and sensing, rather than planar or linear control.

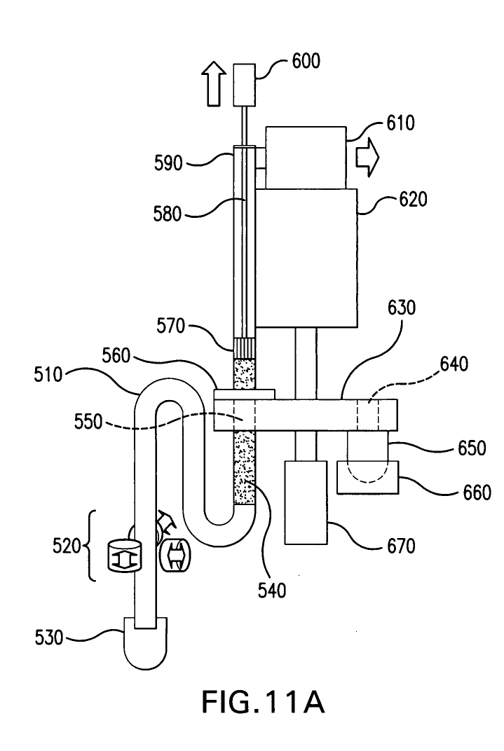

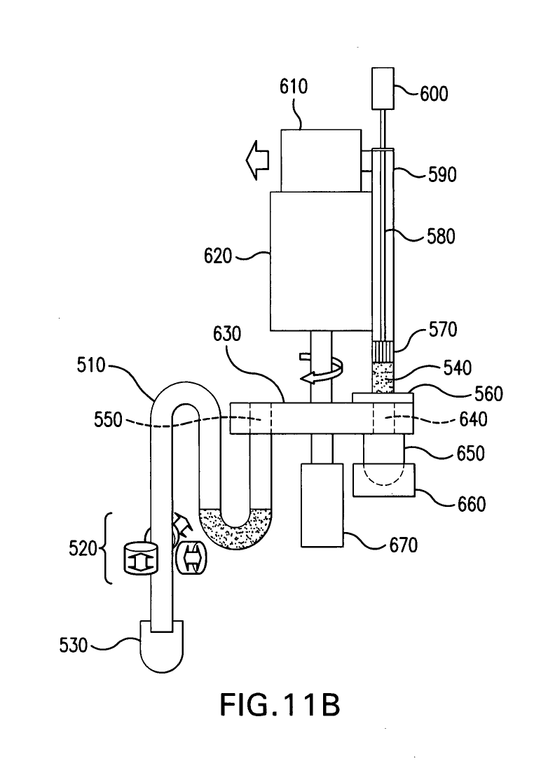

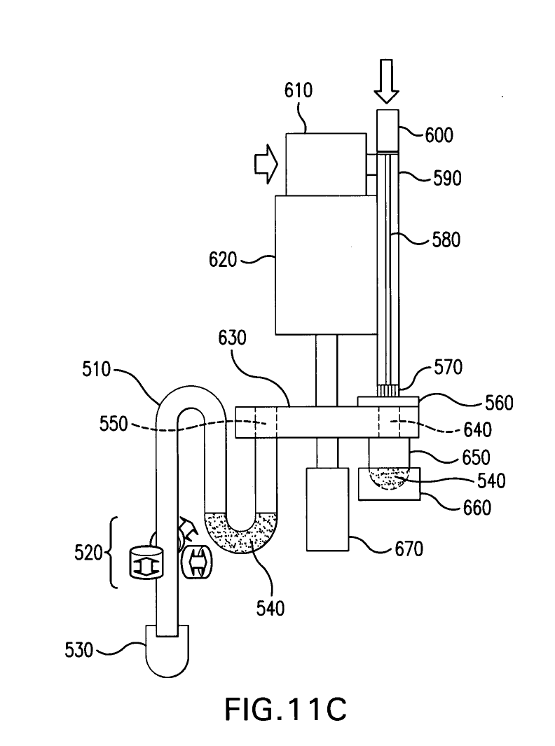

Various aspiration and discharge operations using a rotational configuration are illustrated in FIGS. 11(A)-11(C). According to various embodiments of the present teachings as illustrated in FIG. 11(A), a dispenser apparatus can comprise a tube 510 into which powder 540, such as oligonucleotide beads or other powder, granulate, or other particulate material can be aspirated, drawn, or ingested. According to various embodiments, powder 540 can be aspirated into tube 510 from container 530, which can be positioned over, at the edge of, inside, or otherwise adjacent to or in close proximity to container 530 under control of a set of support motors 520. The set of support motors 520 in various embodiments can comprise three motors, or less or more motors. According to various embodiments, three motors can be used, for example, to drive movement and translation of tube 510 and/or associated components in respective perpendicular or orthogonal (x, y, z) directions. According to various embodiments, other numbers, orientations, and configurations of the set of support motors 520 can be used.

According to various embodiments as shown in FIG. 11(A), tube 510 can be provided in a serpentine or S-shape. According to various embodiments, other shapes or configurations of tube 510 can be used. According to various embodiments, tube 510 can be received, connected, joined, mated, or otherwise attached or registered with a bore 550 in a support 630. According to various embodiments, bore 550 can communicate with a tube 590 in which a piston rod 580 terminating in a piston head 570 is coaxially, slidably mounted. According to various embodiments, tube 590 can have a gasket 560 affixed at one distal end thereof, that mates, registers, or otherwise attaches to or through bore 550 of support 630. According to various embodiments, piston rod 580 can be actuated by a motor 600, such as a linear motor or other motor or other source of mechanical drive.

According to various embodiments, tube 590 can be in fluid communication with an air pump 610, to provide suction or pressure to the interior of tube 590, and thereby aspirate or dispense powder 540 into or out of tube 590, as in other embodiments described herein. According to various embodiments, a peripheral or marginal clearance between piston head 570 and tube 590 can permit a channel or conduit for air flow to produce or communicate suction or pressure during those operations.

According to various embodiments as shown in FIG. 11(A), a rotational support 620 can be mounted and configured to rotate tube 590 and associated components under power of an attached rotational motor 670, to perform various aspiration and discharge operations. According to various embodiments, that rotation can rotate the assembly to align tube 590 over a separate bore 640 in support 630, used as a discharge bore to dispense power 540 under air pressure into a container 650 mounted or supported by a receiving support 660.

In connection therewith, as illustrated in FIG. 11(B), after rotational motor 670 has rotated tube 590 and associated components to align with bore 640, a desired amount of powder 540 can be prepared to be dispensed or ejected into container 650. According to various embodiments, the volume of aspirated power 540 can be set by setting the piston head 570 to a desired height or position within tube 590, under control of volume control motor 600. According to various embodiments, the placement of tube 590, gasket 560, and/or other elements of the assembly in place over bore 640 can be guided by optical or other sensors, and operate under programmed control.

According to various embodiments as illustrated in FIG. 11(C), after tube 590 has been loaded with a desired amount of powder 540 and aligned or registered with bore 640, air pump 610 can be operated to force air through tube 590 to dispense or eject powder 540 through bore 640 and into container 650. According to various embodiments, after powder 540 is dispensed into container 650, support 630 can be rotated by rotational motor 670 to a position as shown in FIG. 11(A), for example to aspirate or acquire additional powder 540. According to various embodiments, dispensing of powder 540 into container 660 can occur before reloading. According to various embodiments, powder 540 can be dispensed into multiple containers or supports. According to various embodiments, powder 540 can be dispensed into a series of containers, for example, a set of containers arranged in an angular array with rotational motor 670 stepping to individual containers or supports, for example, one after the other, for example, in turntable fashion.

According to various embodiments, the aspiration and loading of powder 540 can also be carried out in a sequence of rotations, for example, to aspirate more than one type of powder or other granulate or particulate material. According to various embodiments, in addition to rotational motion of tube 590 and/or associated components, tube 590 and associated components can be other linear, translational, vertical, or other movement. According to various embodiments, for instance, support 630 and/or tube 590 or other components can be moved linearly or vertically to retrieve or place container 660 or other components in shelves at various heights, or to translate container 660 or other components for placement on different supports in different areas of a shelf, table or other surface or area.

According to various embodiments, a dispenser configured according to the present teachings can provide high accuracy or precision in dispensed volume (or corresponding mass), and also a significant selectable volume range. According to various embodiments, the length and/or diameter of a single tube can be chosen to permit a desired range of potential volumes, since greater length and greater diameter each increase the volume of the tube available to fill. According to various embodiments, step-wise differences in volume set by the rod or other volume limiter can be limited only by the degree of precision of the linear motor or other mechanical drive moving that member within the tube.

According to various embodiments involving a set of multiple tubes, these operational advantages are due, at least in part, to dual controls on extracted bead volume, those controls comprising at least a variable number of tubes, as well as a variable volume within those tubes that can be set or manipulated. The individual rods in any one up to all of a set of tubes can be extracted, filling a variable amount of oligonucleotide powder or other material within the tubes, collectively. According to various embodiments, the amount of extraction volume set for each tube in a set of multiple tubes can be made the same. According to various embodiments, the amount of volume set for each tube in a set of tubes can be made to vary together. According to various embodiments of the present teachings, the amount of volume can also be set to vary between different tubes, or be set to vary at different times or extraction runs, providing another dimension with which to adjust volume range and/or accuracy.

According to various embodiments of the present teachings, only one construction of the tip of the rod is needed, since one size or diameter of rod or other volume limiter or other member can be used to effectively manipulate a range of volumes. Moreover, according to various embodiments, a rod, disk, or filter is used that does not trap beads from powder 140, and does not trap other material that is larger than the holes, gaps, passages, or voids, for example, in a filter, avoiding cross-contamination. Further, according to various embodiments, the rod can be extended outside of the fill tube to provide access for removing beads or residual material from powder 140, or for removing other material, lodged inside the fill tube. According to various embodiments, this feature can also provide access to cleaning a filter or volume limiter with forced air or with other gas or liquid scouring agent.

Those skilled in the art can appreciate from the foregoing description that the present teachings can be implemented in a variety of forms. Therefore, while the devices, systems, and methods herein have been described in connection with particular embodiments and examples thereof, the present teachings should not be so limited. Various changes and modifications may be made without departing from the present teachings.

What is claimed:

1. A dispensing system, comprising:
at least one fill tube;
a first volume limiter having a first end and a second end, the second end being movably disposed inside the at least one fill tube to define a receiving volume in the at least one fill tube; and
a pressure source in fluid communication with the receiving volume of the at least one fill tube and configured to aspirate a defined volume of material into the receiving volume of the at least one fill tube.

2. The dispensing system of claim 1, further comprising:
a support, wherein the at least one fill tube is disposed upon the support.

3. The dispensing system of claim 2, further comprising:
one or more support motors in mechanical communication with the support;
wherein the at least fill tube is disposed upon the support, and wherein the one or more support motors are configured to move the support.

4. The dispensing system of claim 3, wherein:
the one or more support motors comprise at least three support motors; and
the at least three support motors are configured to move the support in an X direction, a Y direction, and a Z direction.

5. The dispensing system of claim 3, wherein the one or more support motors are configured to move the support in a rotational direction.

6. The dispensing system of claim 1, further comprising:
a limiter motor in mechanical communication with the first volume limiter;
wherein the limiter motor is configured to move the first volume limiter relative to the at least one fill tube.

7. The dispensing system of claim 1, further comprising a filter disposed at or in the second end of the first volume limiter.

8. The dispensing system of claim 1, wherein the pressure source comprises an air pump.

9. The dispensing system of claim 1, wherein the pressure source is configured to generate at least one of a negative pressure and a positive pressure in at least one of the receiving volume in the at least one fill tube and the first volume limiter.

10. The dispensing system of claim 1, further comprising:
a processor configured to control at least the movement of the first volume limiter and the support.

11. The dispensing system of claim 1, further comprising:
one or more retainment regions disposed adjacent the at least one fill tube;
wherein the one or more retainment regions are configured to retain a powder, and wherein the at least one fill tube is configured to aspirate the powder from the one or more retainment regions.

12. The dispensing system of claim 1, wherein the second end of the first volume limiter is extendable beyond an end of the at least one fill tube to expose the first volume limiter for cleaning.

13. A method of extracting material, comprising:
moving a first volume limiter in at least one fill tube to select a volume of material to be received in the at least one fill tube; and
aspirating the selected volume of material into the at least one fill tube by applying pressure from a pressure source in fluid communication with the at least one fill tube.

14. The method of claim 13, further comprising:
disposing the at least one fill tube on a support; and
moving the support using at least three support motors in mechanical communication with the support, wherein the at least three support motors are configured to move the support in an X direction, a Y direction, and a Z direction.

15. The method of claim 14, wherein the moving comprises moving the support in a rotational direction.

16. The method of claim 13, further comprising:
moving the first volume limiter relative to the at least one fill tube using a limiter motor.

17. The method of claim 13, further comprising:
controlling at least the movement of the first volume limiter and the support using a processor.

18. The method of claim 13, further comprising:
aspirating powder from one or more retainment regions disposed adjacent to the at least one fill tube, into the at least one fill tube.

19. The method of claim 13, further comprising:
extending an end of the first volume limiter beyond an end of the at least one fill tube to expose the first volume limiter; and
cleaning the first volume limiter.
